(19) United States
(12) Patent Application Publication
(10) Pub. No.: US 2019/0176208 A1
(43) Pub. Date: Jun. 13, 2019

(54) CRIMPING MONITORING SYSTEM

(71) Applicant: Lear Corporation, Southfield, MI (US)

(72) Inventors: Andrew J. OZIMEK, Lake Orion, MI (US); Thomas D. BELANGER, JR., New Hudson, MI (US)

(73) Assignee: Lear Corporation, Southfield, MI (US)

(21) Appl. No.: 16/301,036

(22) PCT Filed: May 2, 2017
(86) PCT No.: PCT/US17/30620

§ 371 Date: Nov. 13, 2018

Related U.S. Application Data
(60) Provisional application No. 62/336,103, filed on May 13, 2016.

(51) Int. Cl. B21D 41/04; H01R 43/048

(52) U.S. Cl. CPC B21D 41/04; H01R 43/048

(57) ABSTRACT

A crimping monitoring system includes a sensor configured for electrical connection with at least one of a first element and a second element, and a crimping device including a first crimping fixture and a second crimping fixture. The crimping device may be configured to crimp said first element and said second element together. The sensor may be configured to monitor an electrical characteristic of at least one of said first element and said second element during crimping of said first element and said second element together. The first element may include an electrical terminal and the second element may include a conductor.

### CROSS-REFERENCE TO RELATED APPLICATIONS

This application claims the benefit of U.S. Provisional Patent Application Ser. No. 62/336,103, filed on May 13, 2016, the disclosure of which is hereby incorporated herein by reference in its entirety.

### TECHNICAL FIELD

The present disclosure relates to crimping, electrical terminals, crimping electrical terminals, and methods of monitoring crimping.

### BACKGROUND

This background description is set forth below for the purpose of providing context only. Therefore, any aspects of this background description, to the extent that it does not otherwise qualify as prior art, is neither expressly nor impliedly admitted as prior art against the instant disclosure.

Electrical terminals are often connected to electrical conductors, such as wires, via mechanical processes. Such mechanical processes, which may include crimping, may be difficult to conduct consistently, so it may be desirable to monitor the crimping to evaluate the quality of crimped connections. Crimping may also be applied to non-electrical applications (e.g., tubing, piping, etc.).

There is therefore a desire for solutions/options that address, minimize, or eliminate one or more of the above-described challenges. The foregoing discussion is intended only to illustrate examples of the present field and should not be taken as a disavowal of scope.

### SUMMARY

In embodiments, a crimping monitoring system may include a sensor configured for electrical connection with at least one of a first element and a second element, and a crimping device including a first crimping fixture and a second crimping fixture. The crimping device may be configured to crimp said first element and said second element together. The sensor may be configured to monitor an electrical characteristic of at least one of said first element and said second element during crimping of said first element and said second element together. The first element may include an electrical terminal and the second element may include a conductor. The sensor may be configured for indirect connection with at least one of the terminal and the conductor via at least one of the first crimping fixture and the second crimping fixture. One of the first element and the second element may not be electrically conductive.

With embodiments, in a non-crimping position, the first crimping fixture may be electrically isolated from a remainder of the crimping device and may be electrically connected (e.g., directly) to an electrical ground. The first crimping fixture may include a punch and the second crimping fixture may include an anvil. A crimping device may be configured such that, in a non-crimping position of the first crimping fixture and the second crimping fixture, an electrical current from a current source may flow via a first path to an electrical ground, and in a crimping position of the first crimping fixture and the second crimping fixture, the electrical current from the current source may flow via the first path and a second path. In the non-crimping position, current may not flow via the second path. The second path may include an interface of the first element and second element and a sense resistor of the sensor.

In embodiments, the crimping device may include an applicator supporting at least one of the first crimping fixture and the second crimping fixture. The crimping device may include an actuator configured to actuate at least one of the first crimping fixture and the second crimping fixture, and an electrical connector connecting the applicator with the actuator. The system may include an electronic controller connected to the sensor. At least one of the electronic controller and the sensor may be configured to compensate for a resistance the crimping device.

With embodiments, a method of monitoring crimping may include disposing a first member in contact with a second member, sensing an initial value of an electrical characteristic of at least one of the first member and the second member via an electrical characteristic sensor, crimping the first member with the second member to form a crimped member, sensing a first change in the electrical characteristic, reducing a crimping force, and/or sensing a second change in the electrical characteristic after reducing the crimping force. The method may include determining a quality of the crimped member via comparing the second change to a predetermined value or range. The electrical characteristic may include a voltage drop. The first member may include an electrical terminal and the second member may include a conductor. The first change may include a decrease and the second change may include an increase.

In embodiments, a method of monitoring crimping may include monitoring the electrical characteristic during the crimping and continuing crimping until the electrical characteristic maintains a stable value. Crimping may include applying a compression force to at least one of the first member and the second member via at least one of a first fixture of a crimping device and a second fixture of said crimping device. The method may include obtaining an initial value of an electrical characteristic of a crimping device. The method may include determining a quality of the crimped member, wherein determining said quality includes compensating for an initial value of an electrical characteristic of a crimping device.

The foregoing and other aspects, features, details, utilities, and advantages of the present disclosure will be apparent from reading the following description, and from reviewing the accompanying drawings.

### BRIEF DESCRIPTION OF THE DRAWINGS

FIG. 1 is a perspective view of an embodiment of an electrical terminal.

FIG. 2 is a perspective view of an electrical terminal and a crimping monitoring system according to embodiments of the present disclosure.

FIG. 3A is a schematic of a crimping monitoring system according to embodiments of the present disclosure.

FIG. 3B is a schematic of a crimping monitoring system according to embodiments of the present disclosure.

FIG. 4 is a graph generally illustrating a voltage drop across a crimped connection according to embodiments of the present disclosure.

FIG. 5 is a graph generally illustrating a voltage drop across a crimped connection according to embodiments of the present disclosure.

FIG. 6 is a graph generally illustrating a voltage drop across a crimped connection relative to time and of a crimping force relative to time according to embodiments of the present disclosure.

FIG. 7 is a combined schematic and side view of a crimping monitoring system generally illustrating embodiments of the present disclosure.

FIG. 8 is a combined schematic and side view of a crimping monitoring system according to embodiments of the present disclosure.

FIG. 9 is a flow diagram of a method of monitoring crimping according to embodiments of the present disclosure.

### DETAILED DESCRIPTION

Reference will now be made in detail to embodiments of the present disclosure, examples of which are described herein and illustrated in the accompanying drawings. While the disclosure will be described in conjunction with embodiments and/or examples, it will be understood that they are not intended to limit the present disclosure to these embodiments and/or examples. On the contrary, the present disclosure is intended to cover alternatives, modifications and equivalents, which may be included within the spirit and scope of the present disclosure.

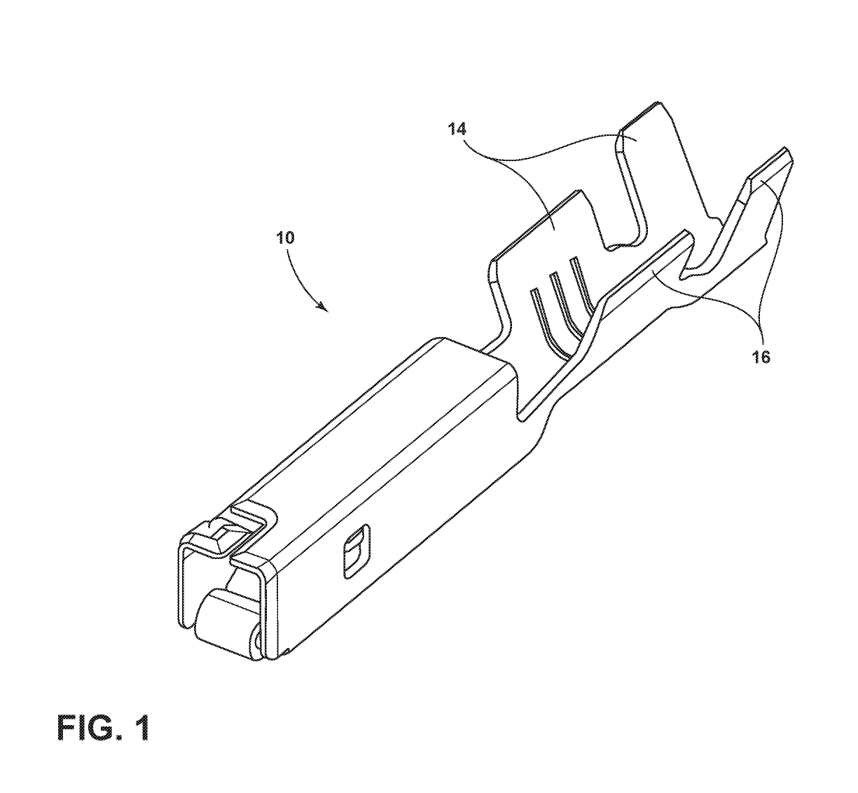

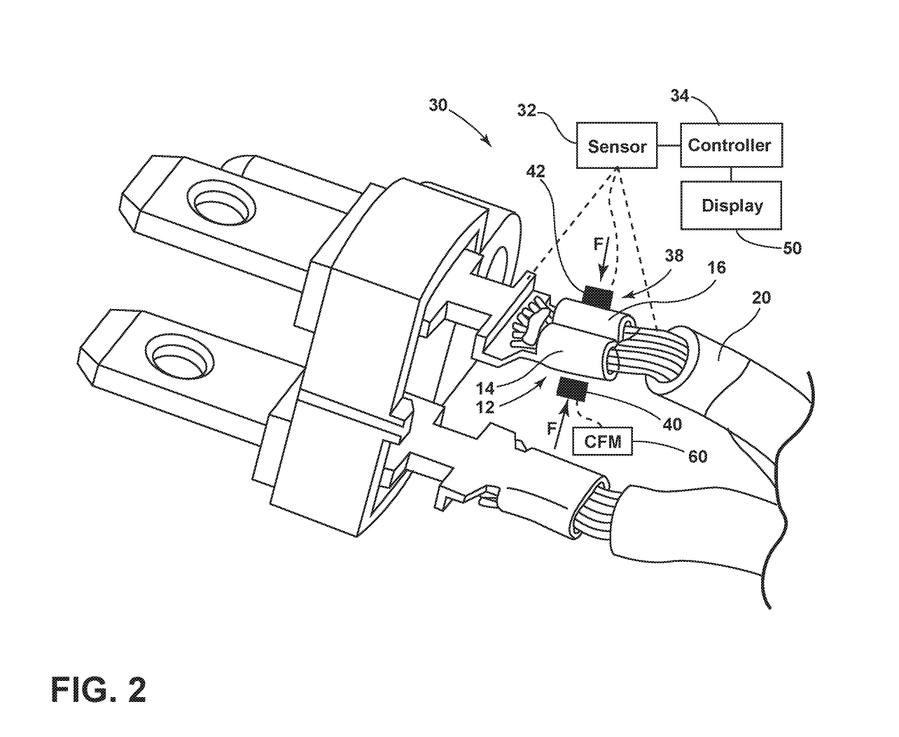

As generally illustrated in FIGS. 1 and 2, in embodiments, a first element (e.g., electrical terminal 10 and/or electrical terminal 12) may be crimped to one or more second elements (e.g., electrical conductor 20, which may include a wire). A first element may be referred to herein as terminal 10 and/or as terminal 12, but is not limited to a terminal. Second elements may be referred to herein as conductors 20, but are not limited to conductors or conducting materials. Crimping may, for example, include applying one or more forces F to certain portions 14, 16 of a terminal 12 such that the terminal portions 14, 16 connect to (e.g., clamp on) a portion of conductor 20 and may limit and/or prevent relative movement between terminal 12 and conductor 20. Additionally or alternatively, crimping may provide and/or improve an electrical connection between a terminal 10, 12 and conductor 20.

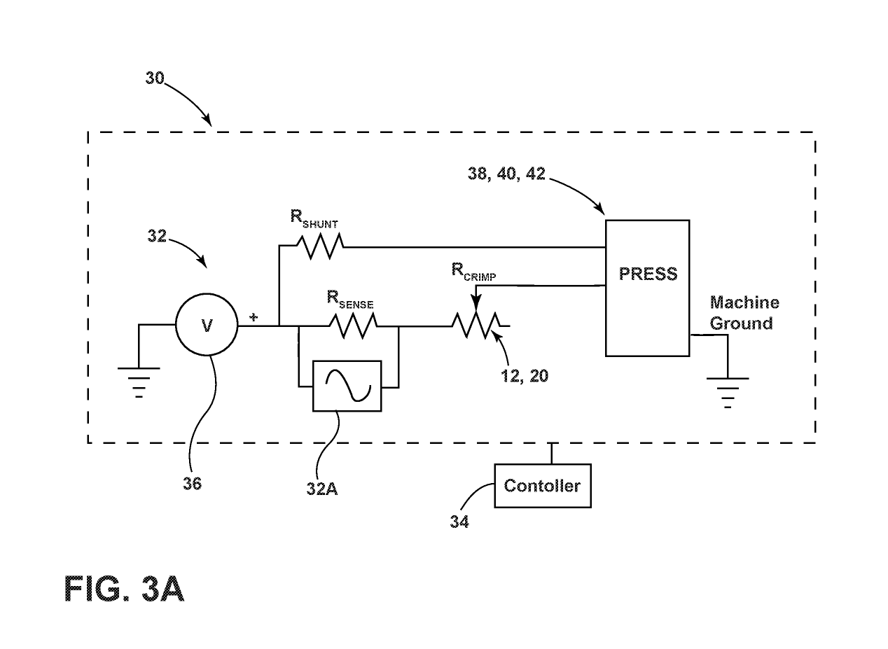

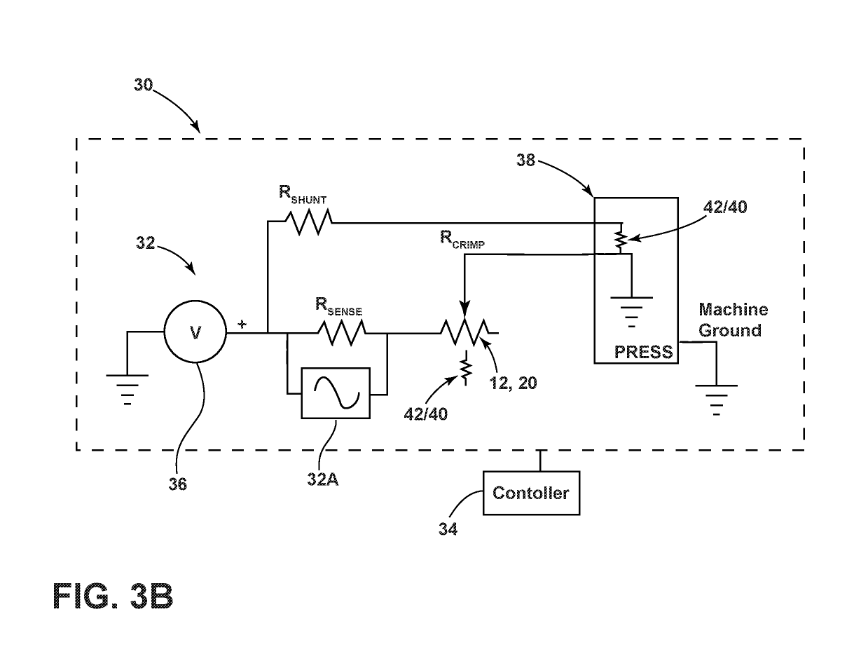

In embodiments, such as generally illustrated in FIGS. 2, 3A, and 3B, a crimping monitoring system 30 may be configured to evaluate or monitor a crimping process. For example, and without limitation, crimping monitoring system 30 may include an electrical characteristic sensor 32 and/or a controller 34. Sensor 32 may be connected (e.g., electrically) to terminal 10, 12 and/or conductor 20. Sensor 32 may or may not be directly electrically connected to terminal 10, 12 and conductor 20 (see, e.g., FIG. 2). Sensor 32 may be connected with and/or include controller 34 and/or a display 50.

With embodiments, sensor 32 may be configured to sense (e.g., measure, monitor, detect, etc.) an electrical characteristic of terminal 12 and/or conductor 20, such as, for example, resistance, impedance, voltage, voltage drop, conductance, capacitance, current, and/or other electrical characteristics. In embodiments, sensor 32 may, for example, comprise a voltage drop sensor 32A (e.g., a voltmeter, an ohmmeter, and/or an ammeter), one or more discrete probes, a sense resistor Rₛₑₙₛₑ, a voltage source/current source 36, and/or a shunt resistor Rₛₕᵤₙₜ. Sensor 32 may be connected to and/or integrated with a crimping machine/device 38, such as a press (e.g., hydraulic, pneumatic, etc.).

In embodiments, controller 34 may include one or more electronic controllers and/or electronic processors, such as a programmable microprocessor and/or microcontroller. In embodiments, controller 34 may include, for example, an application specific integrated circuit (ASIC). Controller 34 may include a central processing unit (CPU), memory, and/or an input/output (I/O) interface. Controller 34 may be configured to perform various functions, including those described in greater detail herein, with appropriate programming instructions and/or code embodied in software, hardware, and/or other medium. In embodiments, controller 34 may include a plurality of controllers and/or may be distributed among various portions of network.

With embodiments, such as generally illustrated in FIGS. 2, 3A, 3B, 7, and 8, controller 34 may be connected (e.g., electrically, wirelessly, via wired connection, etc.) to sensor 32. Controller 34 may be configured to receive data, signals, and/or information from sensor 32 relating to one or more electrical characteristics of terminal 12 and/or conductor 20 sensed by sensor 32.

In embodiments, sensor 32 may sense one or more electrical characteristics of terminal 12, conductor 20, and/or a crimping device 38 during a crimping operation. A crimping operation may include, for example, applying forces F to terminal 12, such as via moving fixtures 40, 42 of a crimping device 38 closer together and/or into contact with each other, which may include electrically connecting fixtures 40, 42 with each other. Applying forces F may cause terminal 12 to clamp/crimp onto conductor 20, which may include bending and/or deformation of terminal portions 14, 16. First fixture 40 may include, for example, a punch. Second fixture 42 may include, for example, an anvil. Clamping/crimping terminal 12 with conductor 20 may restrict and/or prevent relative movement between terminal 12 and conductor 20, and may provide and/or improve (e.g., reduce resistance of, reduce disconnection risk, etc.) an electrical connection between terminal 12 and conductor 20.

In embodiments, such as generally illustrated in FIG. 3B, sensor 32 may be connected to first fixture 40. At least in an initial, non-crimping state, first fixture 40 may be connected to ground and/or electrically isolated from the rest of crimping device 38 (e.g., from second fixture 42, an applicator 44, and/or an actuator/ram 46). For example, and without limitation, crimping device 38 may include an electrical isolator (e.g., a plastic member) between first fixture 40 and applicator 44 and/or actuator 46. First fixture 40 may be selectively connected to terminal 12 and/or conductor 20 (e.g., during crimping). At least in an initial, non-crimping state, second fixture 42 may be electrically isolated from ground and/or the rest of crimping device 38, and may be electrically isolated from first fixture 40 when device 38 is not crimping. In such example configurations, sensor 32 may provide a current (e.g., via voltage/current source 36) to first fixture 40, such as via shunt resistor Rₛₕᵤₙₜ. When first fixture 40 is not crimping (e.g., is out of contact with terminal 12 and/or conductor 20), the sensor current may flow to ground. When first fixture 40 is crimping, the sensor current may also flow through the terminal-conductor interface to a sense resistor Rₛₑₙₛₑ of sensor 32. In embodiments, such an example configuration could be reversed such that sensor 32 may provide current to second fixture 42, and first fixture 40 may be electrically isolated from the rest of device 38 and from ground.

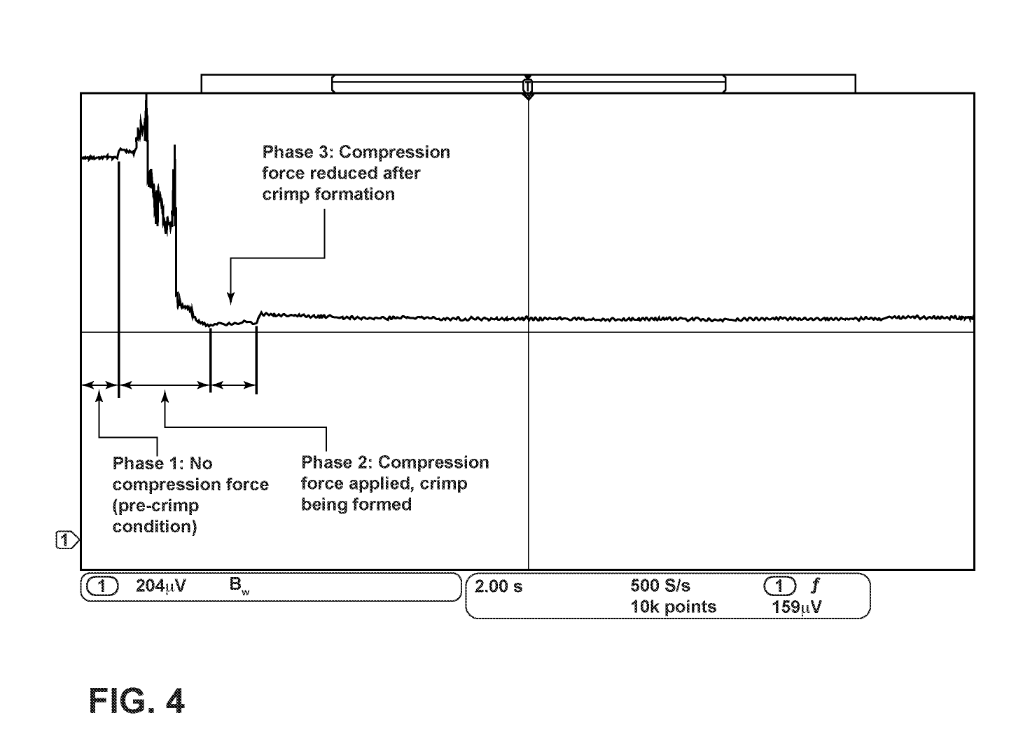

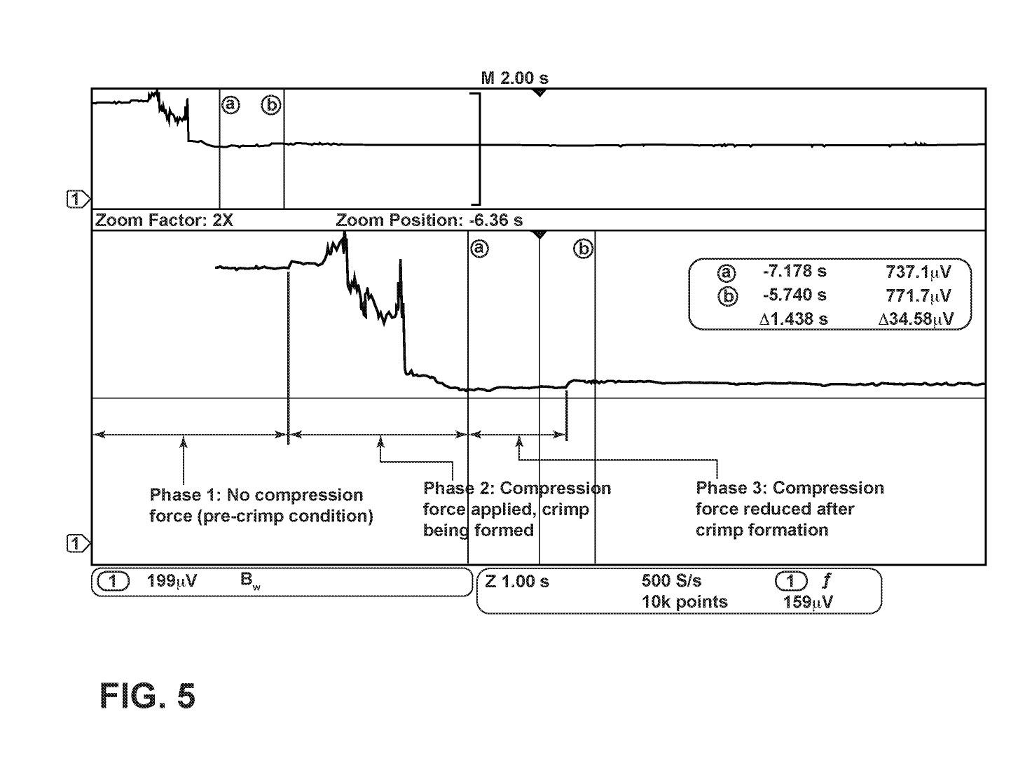

With embodiments, the one or more electrical characteristics that may be sensed by sensor 32 may correspond to, or be indicative of, the quality of the electrical connection between terminal 12 and conductor 20 before, during, and/or after crimping. For example, as generally illustrated in FIGS. 4 and 5, sensor 32 may be configured to sense a voltage drop across the connection/interface between terminal 12 and conductor 20, and the voltage drop may correspond to the electrical resistance and/or quality of the connection. A lower/smaller voltage drop may, for instance, indicate a relatively high quality connection. Quality of the connection may correspond to physical aspects (e.g., strength) of the connection and/or electrical aspects of the connection.

As generally illustrated in FIGS. 4, 5, 6, and 9, crimping may include one or more phases/stages. For example, in a first phase, terminal 12 and conductor 20 may be placed in proximity and/or contact with each other without any compression/crimping force F being applied. In a first phase, a voltage drop and/or resistance sensed by sensor 32 may be relatively high. In a second phase, compression/crimping force F may be applied to form a crimped terminal 12. The voltage drop and/or resistance sensed by sensor 32 may generally decrease as force F is applied. Force F may be applied, for example, until a generally stable value of the electrical characteristic is reached. In a third phase, force F may be reduced and/or removed, and the voltage drop and/or resistance sensed by sensor 32 may increase, at least slightly, as force F decreases. An increase in a voltage drop may correspond to, or be indicative of, an elasticity of terminal 12 and/or conductor 20, which may comprise, in an embodiment, copper. For example, and without limitation, applying crimping force F to terminal 12 and/or conductor 20 may reduce a voltage drop to about 737 μV, and/or the removal/reduction of crimping force F may result in an increase of the voltage drop to about 772 μV (e.g., a change of about 35 μV or about 5%).

In embodiments, controller 34 may include and/or be connected to a display 50 and may be configured to cause display 50 to present visual representations or graphs of sensed electrical characteristics, such as the graphs shown in FIGS. 4, 5, and 6. In embodiments, controller 34 may be configured to determine if a crimped connection/interface is of sufficiently high quality. For example, and without limitation, controller 34 may analyze a voltage drop sensed during or after a second phase and/or third phase of crimping and compare that voltage drop to an expected voltage drop. If the sensed voltage drop is within a predetermined/specified range, controller 34 may determine that the connection is of sufficient quality. If the sensed voltage drop is outside of a predetermined/specified range, controller 34 may determine that the connection is not of a sufficient quality and/or that an error has occurred. Controller 34 may be configured to display a quality of the connection and/or an error message on display 50.

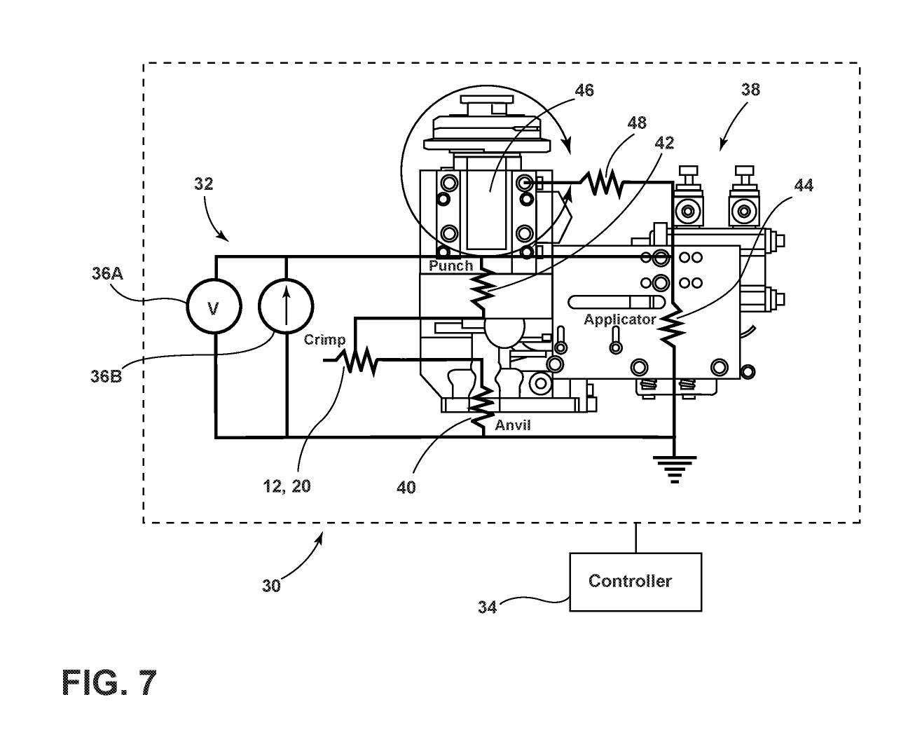

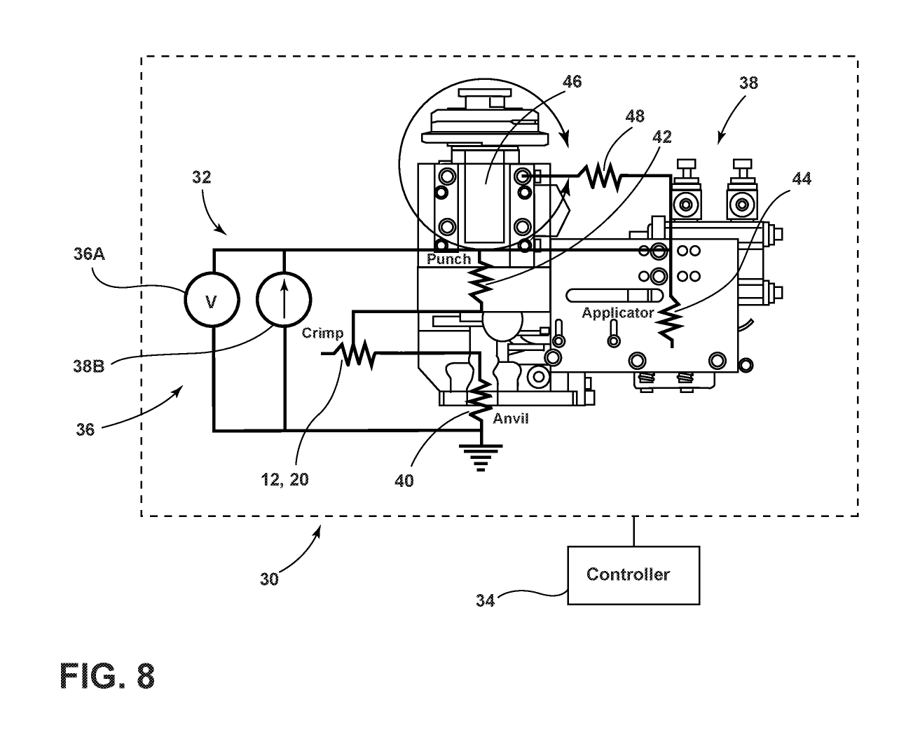

In embodiments, such as generally illustrated in FIGS. 7 and 8, sensor 32 of crimping monitoring system 30 may connect with terminal 12 and/or conductor 20 via first fixture 40 (e.g., a punch) and/or second fixture 42 (e.g., an anvil). Applicator 44 may support at least one of first fixture 40 and second fixture 42. First fixture 40 and/or second fixture 42 may or may not be connected (e.g., electrically) with an applicator 44 of crimping device 38. Crimping device 38 may include an actuator 46 (e.g., a ram) that may be configured to actuate first fixture 40 (e.g., may move first fixture 40 toward second fixture 42 to cause crimping). System 30 may compensate for the resistance of first fixture 40, second fixture 42, applicator 44, and/or actuator 46 when monitoring crimping. For example, and without limitation, sensor 32 and/or controller 34 may be configured to determine/obtain a resistance (or expected voltage drop) of first fixture 40, second fixture 42, applicator 44, and/or actuator 46 such as prior to crimping and/or prior to connecting terminal 12 with conductor 20. With embodiments, a resistance of applicator 44 may be about 0.4 Ohms, for example. If terminal 12 and conductor 20 are disposed in contact with fixtures 40, 42, fixtures 40, 42 may be electrically connected in series with each other, terminal 12, and conductor 20, all of which may be electrically connected in parallel with applicator 44. Sensor 32 and/or controller 34 may be configured to compensate for (e.g., remove/ignore the effects of) the resistance of fixture 40, fixture 42, and/or applicator 44 while monitoring crimping. In embodiments, a resistance of one or more components of system 30 may be preloaded/stored in sensor 32 and/or controller 34.

In embodiments, such as generally illustrated in FIG. 8, applicator 44 may be electrically insulated from ground and/or from second fixture 42. In such embodiments, an initial resistance (or voltage drop) may reflect, or be indicative of, an open circuit until terminal 12 and/or conductor 20 are disposed in contact with fixtures 40, 42. If sensor 32 is connected to terminal 12 and/or conductor 20 via first fixture 40 and/or second fixture 42, system 30 may be configured to monitor crimping (e.g., sense an electrical characteristic), even if one of terminal 12 and conductor 20 is not electrically conductive (e.g., a voltage drop/resistance across fixtures 40, 42 and the conductive one of terminal 12 and conductor 20 may change during crimping). One of terminal 12 and conductor 20 may not be conductive, for example, for insulation crimps and/or sealing crimps.

With embodiments, during a crimp cycle, actuation of first fixture 40 via actuator 46 may include sliding movement of first fixture 40 and/or actuator 46, which may alter (e.g., increase) a resistance of crimping device 38. As generally illustrated in FIGS. 7 and 8, crimping device 38 may include a connector 48 that may be configured to provide an electrical connection (e.g., a low resistance connection that may effectively act as a short) between applicator 44 and actuator 46 to reduce, minimize, and/or eliminate the effect of such a change in resistance. Connector 48 may include, for example, a braid strap.

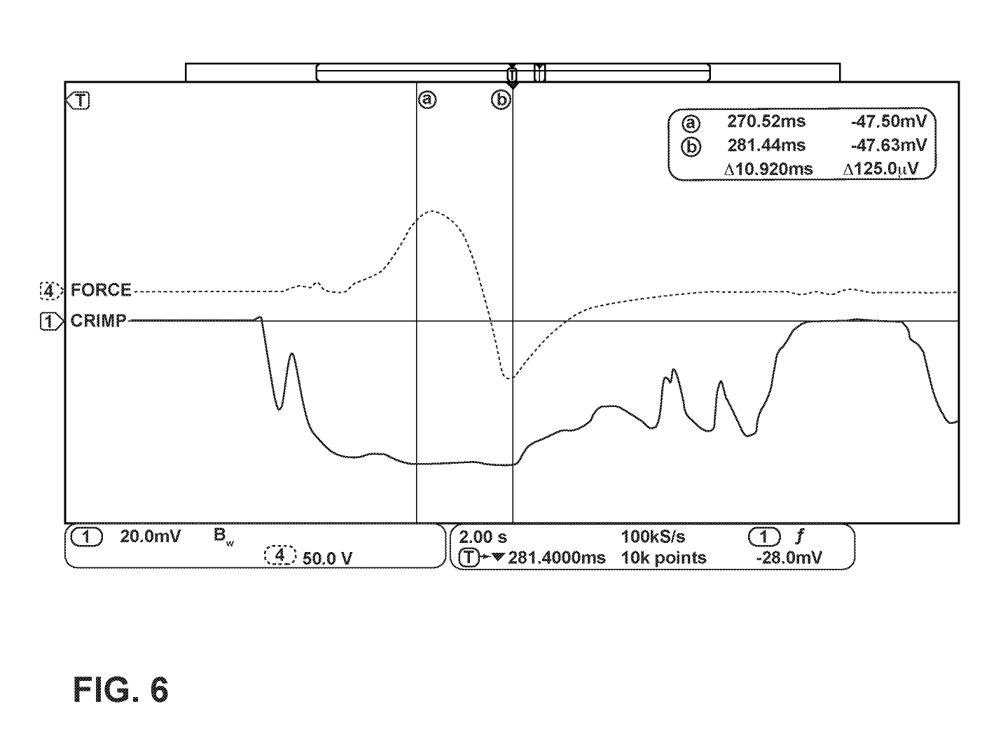

In embodiments, crimping monitoring system 30 may include a crimping force sensor 60 (see, e.g., FIG. 2). Crimping force sensor 60 may be configured to monitor crimping force F before, during, and/or after crimping (e.g., during the first, second, and/or third phases). Crimping force sensor 60 may be connected to controller 34. Crimping force sensor 60 may be configured for generating a force profile (see, e.g., FIG. 6) that may correspond to a crimp height and/or compaction of conductor 20. Crimping force sensor 60 may be configured for generating the force profile via controller 34. System 30 may be configured to (e.g., simultaneously) monitor one or more electrical characteristics of crimping device (e.g., voltage drop across a connection interface) and crimping forces F.

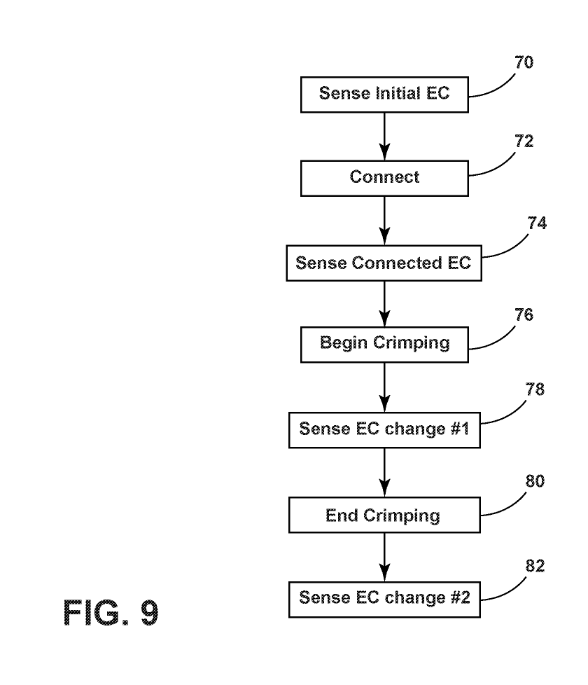

As generally illustrated in FIG. 9, in embodiments, a method of crimping and/or monitoring crimping may, in step 70, include a sensor 32 sensing/obtaining one or more initial values of one or more electrical characteristics (e.g., a voltage drop) of system 30. In step 72, sensor 32 may be connected to at least one of terminal 12 and conductor 20. In step 74, sensor 32 may sense an initial value of an electrical characteristic (e.g., a voltage drop) of an interface of terminal 12 and conductor 20. In step 76, a crimping force F may be applied to terminal 12 and/or conductor 20, and sensor 32 may sense the electrical characteristic of terminal 12 and/or conductor 20 while the crimping force F is being applied. In step 78, sensing may include sensing a change (e.g., a decrease) in the electrical characteristic during a second phase of crimping (e.g., while crimping forces F are being applied). In step 80, crimping may be ended, crimping forces F may be reduced, and/or crimping forces F may be removed. In step 82, sensing may include sensing a second change (e.g., an increase) in the electrical characteristic during a third phase of crimping (e.g., as or after crimping forces F are removed). If the first change and/or second change is outside of a predetermined/specified range, controller 34 may determine that the connection is not of a sufficient quality and/or that an error has occurred. Additionally or alternatively, controller 34 may determine that the connection is not of a sufficient quality and/or that an error has occurred if a compression force sensor 60 indicates a compression force that is not within a specified/predetermined range. Controller 34 may be configured to control operation of crimping device 38 (e.g., movement of first fixture 40, second fixture 42, and/or applicator 44), such as according to information received from sensor 32.

In embodiments, connecting sensor 32 to terminal 12 and conductor 20 may include indirectly connecting sensor 32 to terminal 12 and/or conductor 20. For example, and without limitation, sensor 32 may be directly connected to fixture 40 and fixture 42, which may be directly connected with terminal 12 and/or conductor 20. At least one of terminal 12 and conductor 20 may not be electrically conductive. For example, and without limitation, if one of terminal 12 and conductor 20 is not electrically conductive, sensor 32 may be configured to monitor and/or determine a crimp quality according to an electrical characteristic of the conductive one of terminal 12 and conductor 20 via first fixture 40 and/or second fixture 42.

With embodiments, voltage/current source 36 of sensor 32 may include voltage source 36A and/or a current source 36B. In embodiments, sensing an electrical characteristic may include providing a voltage and/or a current (e.g., via a voltage/current source 36, a voltage source 36A, and/or a current source 36B) to one or more of terminal 12, conductor 20, fixture 40, fixture 42, and/or applicator 44. A provided current may include, for example, and without limitation, include a substantially constant current of about 1 Ampere.

Although various features and functions of certain embodiments have been described herein in connection with terminal 12 for illustration, such embodiments are not limited to a certain type of terminal and could be used in connection with a wide range of elements, including, without limitation, terminal 10.

With embodiments, a crimping monitoring system 30 may include a sensor 32 that may be configured for electrical connection with a first element 10, 12 and/or a second element 20. System 30 may include a crimping device 38 that may include a first crimping fixture 40 and a second crimping fixture 42. Crimping device 38 may be configured to crimp said first element 10, 12 and said second element 20 together. Sensor 32 may be configured to monitor an electrical characteristic of at least one of said first element 10, 12 and said second element 20 during crimping (e.g., via first fixture 40 and/or second fixture 42). The sensor may be configured for indirect electrical connection with at least one of first element 10, 12 and second element 20 via at least one of first crimping fixture 40 and second crimping fixture 42.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “with embodiments,” “in embodiments,” or “an embodiment,” or the like, means that a particular feature, structure, or characteristic described in connection with the embodiment is included in at least one embodiment. Thus, appearances of the phrases “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of “e.g.” throughout the specification is to be construed broadly and is used to provide non-limiting examples of embodiments of the disclosure, and the disclosure is not limited to such examples. Uses of “and” and “or” are to be construed broadly (e.g., to be treated as “and/or”). For example, and without limitation, uses of “and” do not necessarily require all elements or features listed, and uses of “or” are intended to be inclusive unless such a construction would be illogical.

It is intended that all matter contained in the above description or shown in the accompanying drawings shall be interpreted as illustrative only and not limiting. Changes in detail or structure may be made without departing from the present disclosure.

Furthermore, the mixing and matching of features, elements and/or functions between various examples is expressly contemplated herein so that one of ordinary skill in the art would appreciate from this disclosure that features, elements, and/or functions of one example may be incorporated into another example as appropriate, unless described otherwise, above. Moreover, many modifications may be made to adapt a particular situation or material to the teachings of the present disclosure without departing from the scope thereof. Therefore, it is intended that the present teachings not be limited to the particular examples illustrated by the drawings and described in the specification, but that the scope of the present disclosure will include any embodiments falling within the foregoing description and the appended drawings.

What is claimed is:

1. A crimping monitoring system, comprising:
a sensor configured for electrical connection with at least one of a first element and a second element; and
a crimping device including a first crimping fixture and a second crimping fixture, the crimping device configured to crimp said first element and said second element together;
wherein the sensor is configured to monitor an electrical characteristic of at least one of said first element and said second element during crimping of said first element and said second element together.

2. The system of claim 1, wherein the first element includes an electrical terminal and the second element includes a conductor.

3. The system of claim 2, wherein the sensor is configured for indirect connection with at least one of the electrical terminal and the conductor via at least one of the first crimping fixture and the second crimping fixture.

4. The system of claim 1, wherein one of the first element and the second element is not electrically conductive.

5. The system of claim 1, wherein, in a non-crimping position, the first crimping fixture is electrically isolated from a remainder of the crimping device and is electrically connected to an electrical ground.

6. The system of claim 1, wherein the first crimping fixture includes a punch and the second crimping fixture includes an anvil.

7. The system of claim 1, wherein the crimping device is configured such that, in a non-crimping position of the first crimping fixture and the second crimping fixture, an electrical current from a current source flows via a first path to an electrical ground, and in a crimping position of the first crimping fixture and the second crimping fixture, the electrical current from the current source flows via the first path and a second path.

8. The system of claim 7, wherein the second path includes an interface of the first element and second element and a sense resistor of the sensor.

9. The system of claim 1, wherein the crimping device includes an applicator supporting at least one of the first crimping fixture and the second crimping fixture.

10. The system of claim 9, wherein the crimping device includes an actuator configured to actuate at least one of the first crimping fixture and the second crimping fixture, and an electrical connector connecting the applicator with the actuator.

11. The system of claim 1, comprising an electronic controller connected to the sensor, wherein at least one of the electronic controller and the sensor is configured to compensate for a resistance of the crimping device.

12. A method of monitoring crimping, the method comprising:
disposing a first member in contact with a second member;
sensing an initial value of an electrical characteristic of at least one of the first member and the second member via an electrical characteristic sensor;
crimping the first member with the second member to form a crimped member;
sensing a first change in the electrical characteristic;
reducing a crimping force; and
sensing a second change in the electrical characteristic after reducing the crimping force.

13. The method of claim 12, comprising determining a quality of the crimped member via comparing the second change to a predetermined value or range.

14. The method of claim 13, wherein the electrical characteristic includes a voltage drop.

15. The method of claim 12, wherein the first member includes an electrical terminal and the second member includes a conductor.

16. The method of claim 12, wherein the first change is a decrease and the second change is an increase.

17. The method of claim 12, comprising monitoring the electrical characteristic during the crimping and continuing crimping until the electrical characteristic maintains a stable value.

18. The method of claim 12, wherein crimping includes applying a compression force to at least one of the first member and the second member via at least one of a first fixture of a crimping device and a second fixture of said crimping device.

19. The method of claim 12, comprising obtaining an initial value of an electrical characteristic of a crimping device.

20. The method of claim 12, comprising determining a quality of the crimped member, wherein determining said quality includes compensating for an initial value of an electrical characteristic of a crimping device.
